(19) United States
(12) Patent Application Publication
(10) Pub. No.: US 2006/0048990 A1
(43) Pub. Date: Mar. 9, 2006

(54) Fat tire assembly

(76) Inventor: Paul Julio Civitello, Waterbury, CT (US)

Correspondence Address: Paul Julio Civitello, 35 Harpersferry Rd., Waterbury, CT, 06705, US

(21) Appl. No.: 10/935,932

(22) Filed: Sep. 7, 2004

(51) Int. Cl. B62M 7/00

(52) U.S. Cl. 180/226

(57) ABSTRACT

The purpose of my invention the Fat-Tire Kit is to allow a Shaft-drive motorcycle to have a 300 mm tire mounted on the motorcycle rear wheel. A 250 mm or 280 mm tire could also be installed if desired. The rear motorcycle wheel with the 250 mm, 280 mm or 300 mm tire mounted will remain in the center of the motorcycle with no off-set, because of my special swing-arm with the transmission case incorporated into it. My Fat-Tire invention will allow the simple installation of a Fat-Tire. The ability to remain in the center of the motorcycle will allow the rider to have the same control of the motorcycle as a factory stock rear wheel and tire which is in the center of the motorcycle. The Fat-Tire invention is a unique system that allows you to have the capability of having a larger tire mounted on the rear of the motorcycle that is cosmetically appealing and has superior traction while the wheel and tire stay in the center of the motorcycle where it belongs.

Rear Frame swing-arm assembly with transmission incorporated into it. The Fat Tire Assembly is for a shaft drive motorcycle rear wheel installation with up to a 300 mm tire mounted on the wheel. The wheel with the 300 mm tire mounted remains in the center of the motorcycle with no offset.

The reason for my invention of the Fat-Tire Assembly is that there is a tremendous demand for the use of a wider tire and wheel.

### CROSS REFERENCE TO RELATED APPLICATION

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention relates to a motorcycle frame rear shaft drive swing-arm section, with a transmission incorporated into it. Specifically to accommodate any wider size motorcycle tire available to date.

The Main and most important advantage of my Fat Tire Kit is that it keeps the wheel in the center of the motorcycle with no offset and also strengthens the swing arm, unlike traditional methods available to date which are to move the wheel and tire away from the drive shaft giving it clearance putting the wheel off center, which is not a good practice.

Without my invention it would be impossible to incorporate into a traditional shaft drive swing-arm, a 250, 280. Or 300 millimeter motorcycle rear wheel and tire that would be able to remain in the center of the motorcycle.

This unique system allows you to have the capability of having a larger tire that is cosmetically appealing and has superior traction while the wheel and tire stay in the center of the motorcycle where it belongs.

### BRIEF SUMMARY OF THE INVENTENTION

A).To provide any shaft drive motorcycle the ability to accommodate a motorcycle rear wheel and tire up to a size 300 mm, positioned in the center of the motorcycle.

B). my offset transmission that is incorporated into the swing arm keeps the rear wheel in perfect alignment in the center of the motorcycle.

C). the design of the swing-arm gives the rear motorcycle frame rear shaft section, superior strength and stability.

### BRIEF DESCRIPTION OF THE DRAWINGS

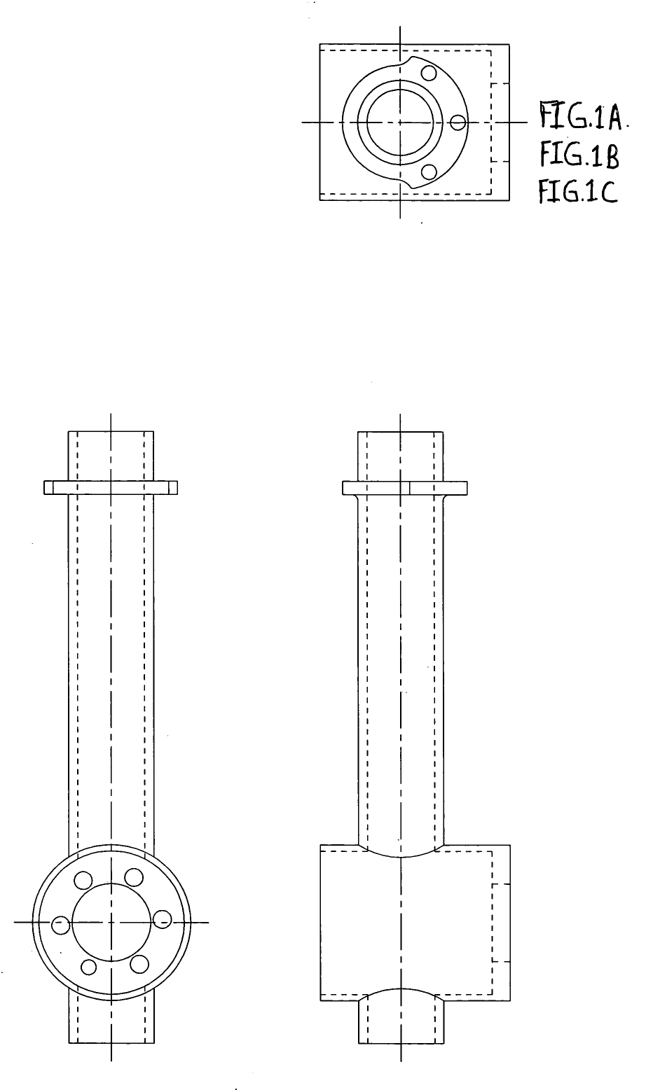

Drawings of my invention are attached. Drawing FIG. 1A. is the front swing-arm supporting cross member: that is made of 41/30 chrome molly, and manufactured on a lathe, the drawing shows the front swing-arm supporting cross member. Said component has the transmission support housing and right hand flange is tig welded to front swing arm supporting cross member said component pivots off the main center frame of the motorcycle, said component also supports the rotary transmission door and case said component attaches by tapered thrust bearings to the main motorcycle frame, and also supports the right side axel arm.

Drawing FIG. 1B is the right hand flange: that is made of 41/30 chrome molly and manufactured on a lathe. Said component is welded to the front Swing-Arm Support Cross member to support the axel arm right side

Drawing FIG. 1C is Transmission Door Housing: that is made of 41/30 chrome molly is manufactured on a lathe and milling machine. Its main function is to support the rotary transmission.

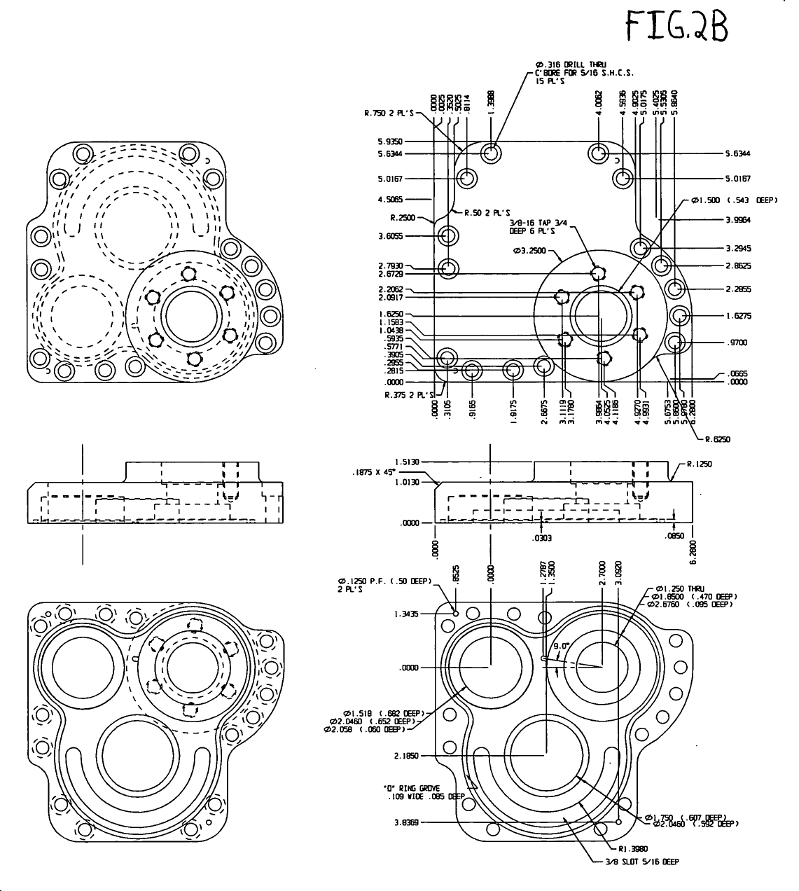

Drawing FIG. 2B is the Transmission Door: that is made of 20/24 billet aluminum and manufactured on a milling machine. Said component has roller bearings for support. The transmission rotary means said component attaches to the front swing-arm supporting cross member by means of 6⅜ Allen head cap screws. Said component has an O ring grove machined into it.

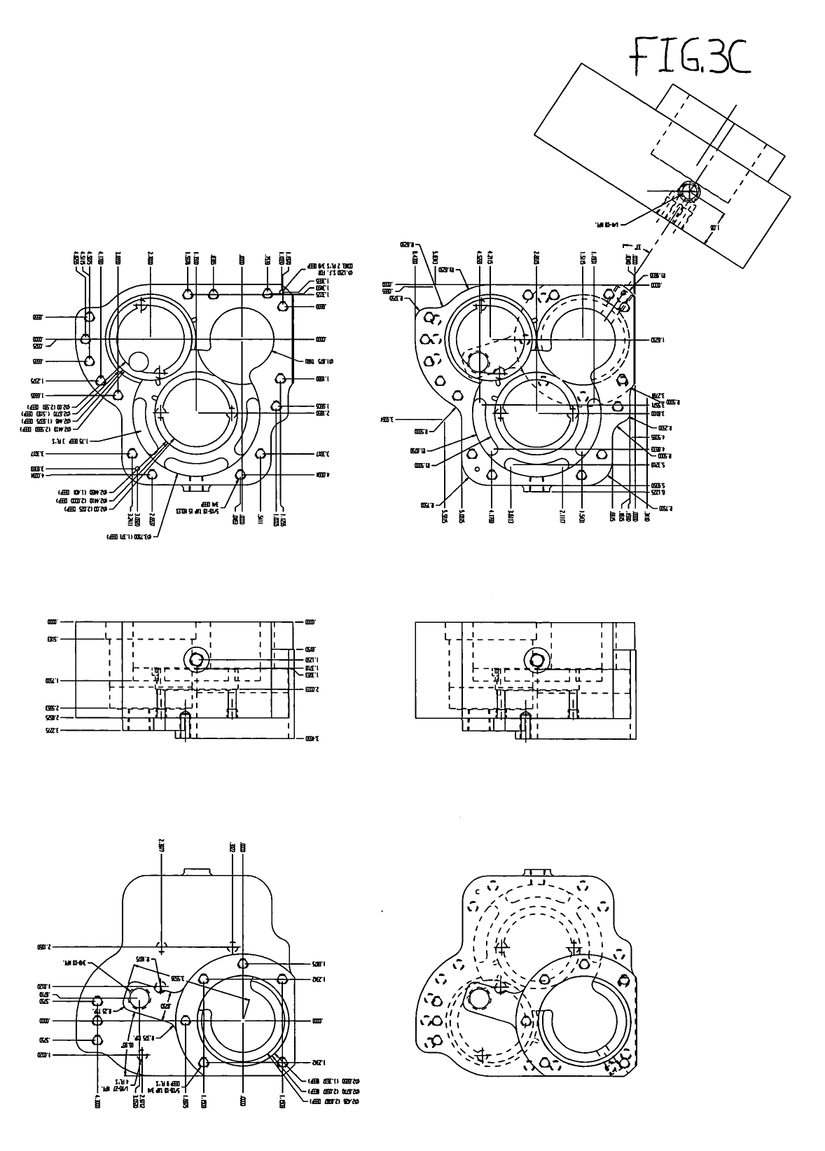

Drawing FIG. 3C is the Transmission Case: that is made of 20/24 billet aluminum and manufactured on a milling machine said component attaches to transmission door by means of 15 5/16 Allen head cap screws. Said component has rear mount machined into it to support adjustable axel arm end. Said component has an oil sight glass machined into rear side of the case, and has a drain plug located on the bottom. Said component also has a venting fitting in top left corner.

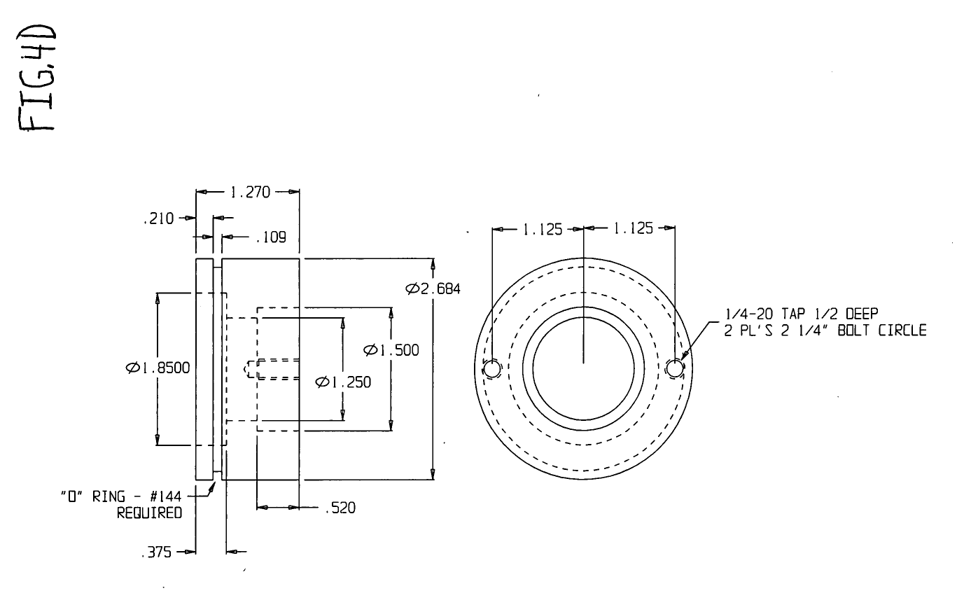

Drawing FIG. 4D is an Oil Seal Housing: that is made of 20/24 billet aluminum and manufactured on a lathe. Said component seals the rotary transmission means. Said component has 2 sealing components. The 2 quarter inch holes located on rear face are for easy removal.

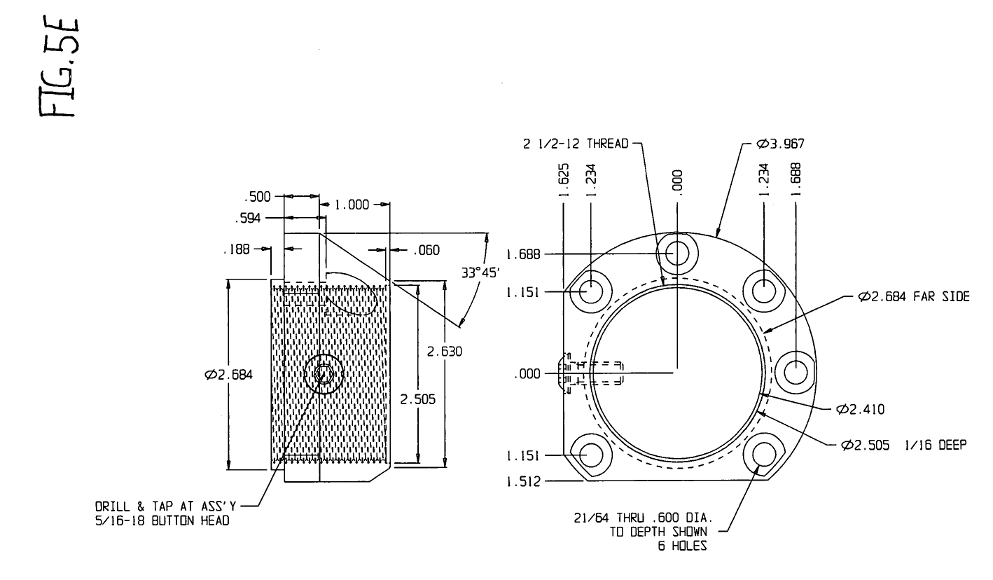

Drawing FIG. 5E is an Adjustable Axel Arm End: that is made of 20/24 billet aluminum and manufactured on a lathe and milling machine. Said component connects to rear transmission case and said component also supports the adjustable axel arm. The adjustable axel arm end attaches to the transmission case by 6 5/16 Allen head cap screws.

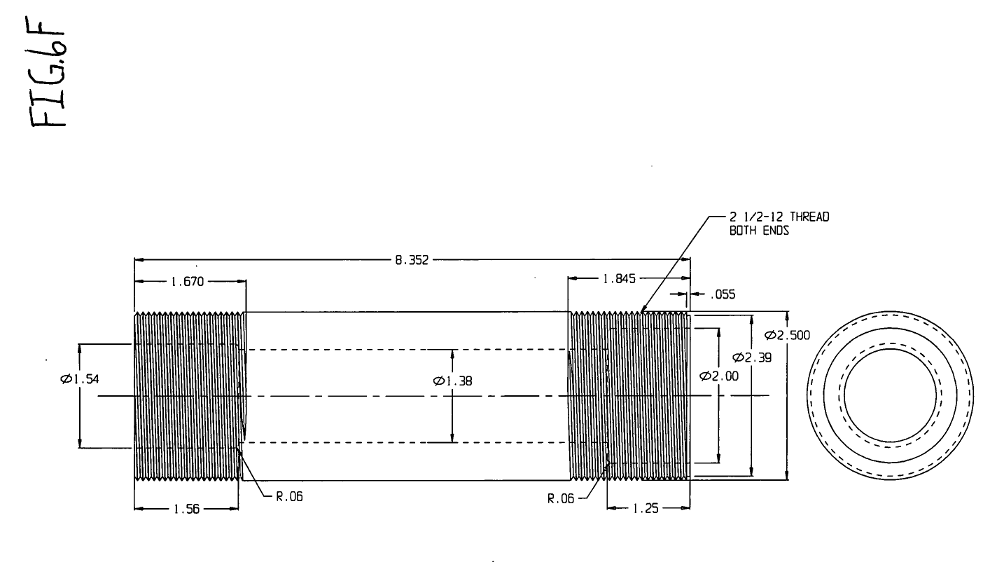

Drawing FIG. 6F is an Adjustable Axel Arm: that is made of 20/24 billet aluminum and manufactured on a lathe. Said component is one of the components that support the rear axel.

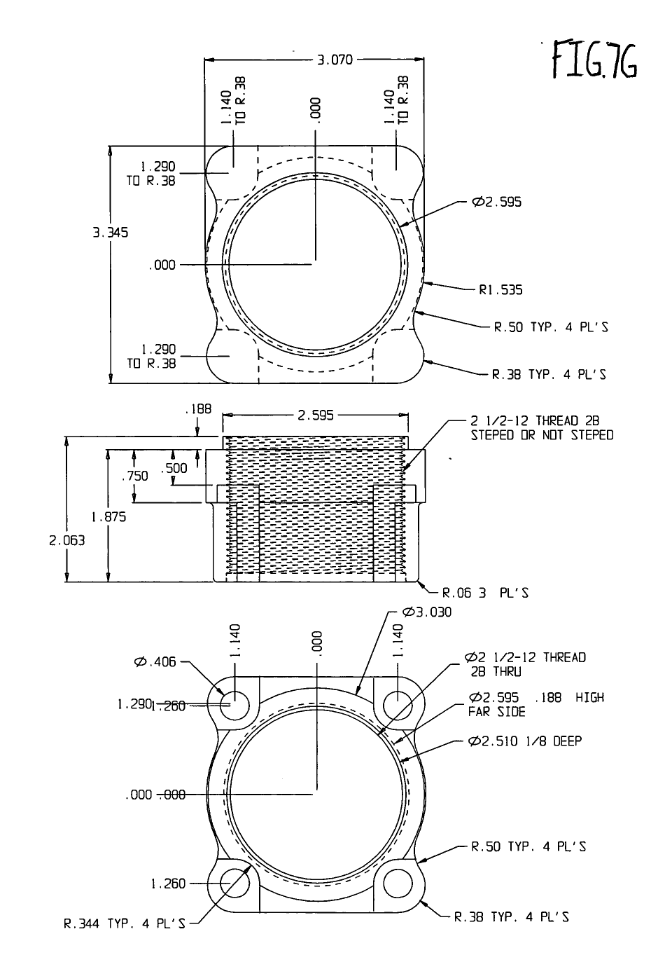

Drawing FIG. 7G is an Adjustable Axel Arm Flange: that is made of 20/24 billet aluminum and manufactured on a lathe and milling machine. Said component supports the final drive unit.

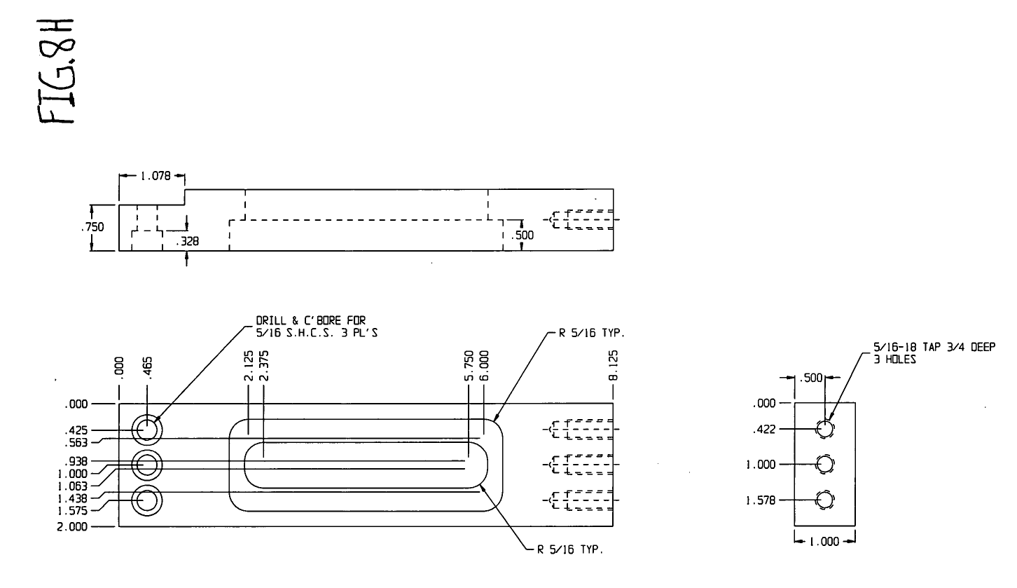

Drawing FIG. 8H is a Cross Support: that is made of 20/24 billet aluminum and manufactured on a milling machine. Said component attaches to the transmission case horizontally to right side of axel arm. Said component attaches by means of 6 5/16 Allen head cap screws. Said component gives added support to the total assembly.

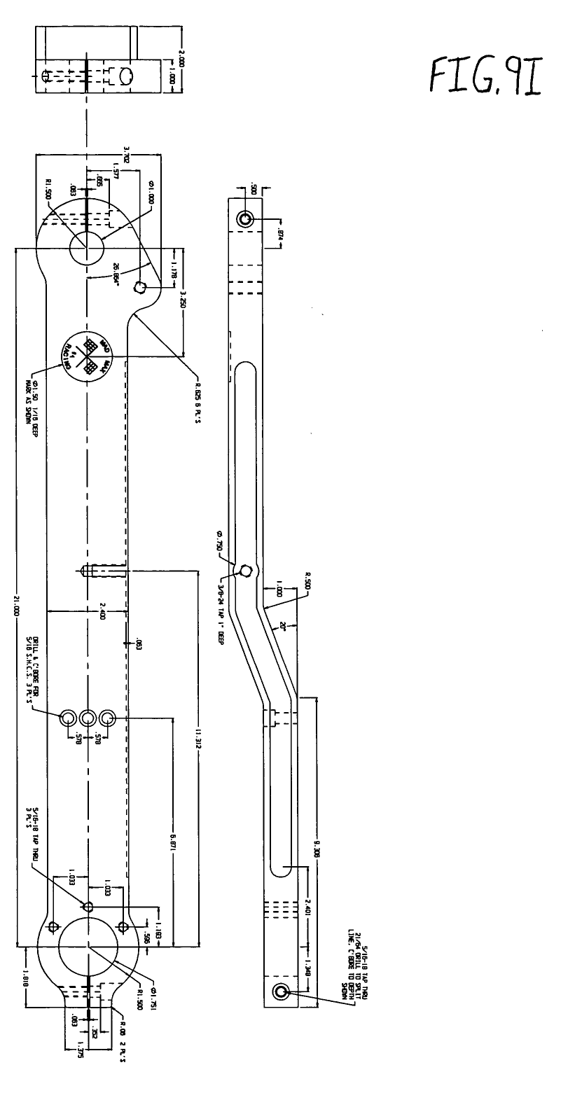

Drawing FIG. 9I is a Right Axel Arm: that is made of 20/24 billet aluminum and manufactured on a milling machine. A said component attaches to the front swing arm support cross member by means of 4 5/16 Allen head cap screws, and also has a rear shock mount machined right into it and a brake rod hime joint support hole middle top side. Said component connects to support the right hand flange. Machined into right axel arm is the Mad Max Racing logo.

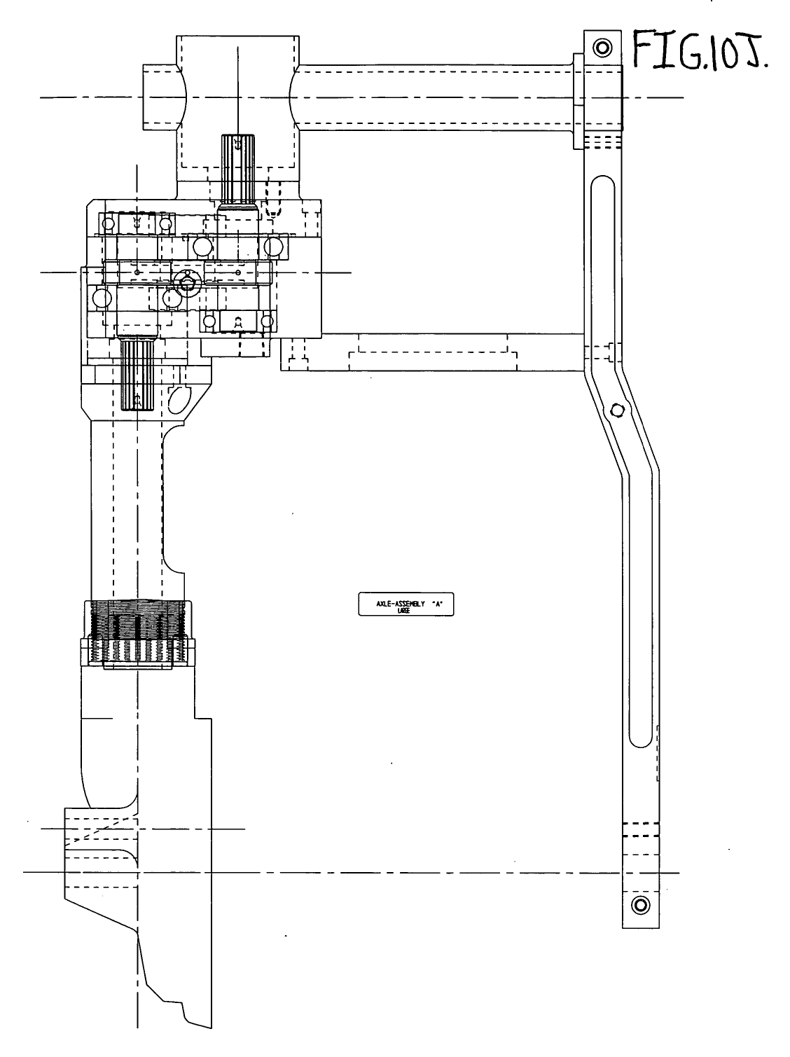

Drawing FIG. 10J is an assembled view of the entire unit. The assembled view is a drawing of the rotary transmission means with the swing-arm incorporated into it, and the final drive. Said drawing is also a view of the gear configuration with roller bearing locations.

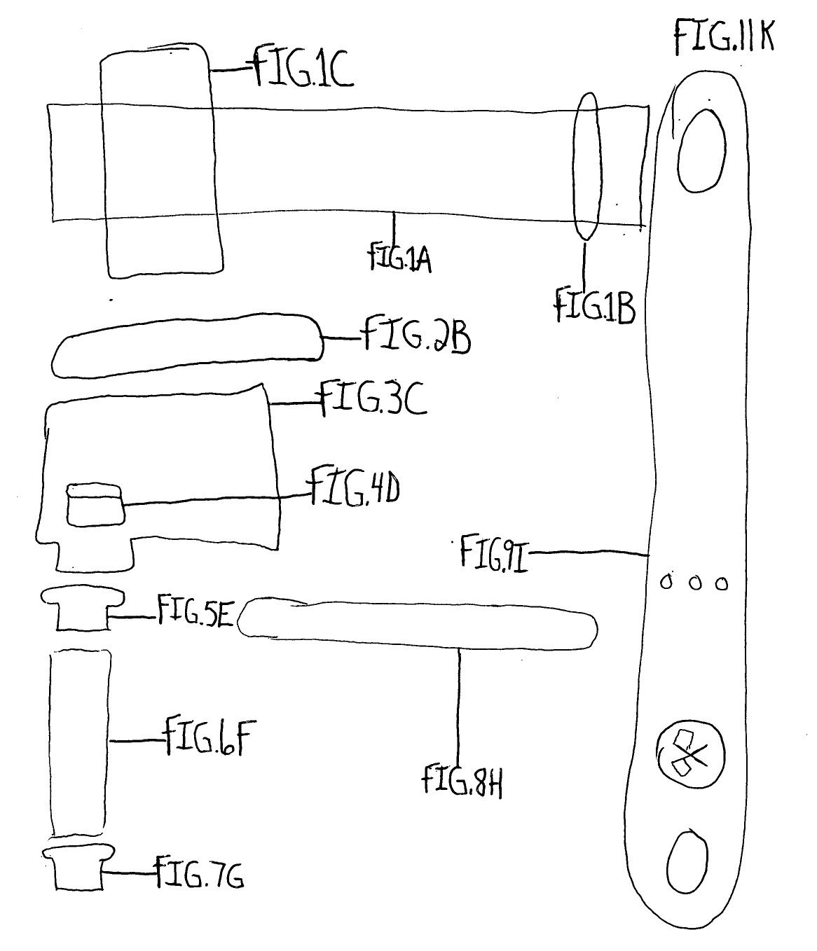

Drawing FIG. 11K is a hand written reference of parts included in the Fat Tire Assembly.

### DETAILED DESCRIPTION

The Fat Tire Assembly invention is a unique system that allows the installation of a wide rim and tire on the rear of a shaft driven motorcycle, with no offset. The wheel with mounted tire remains in the center of the motorcycle. The reason for the centered stability of the wheel and tire is my special swing-arm assembly with the transmission built in FIG. 2B and FIG. 3C. The Fat Tire assembly will accept a 250 mm, 280 mm, or 300 mm tire and wheel on the rear of any shaft drive motorcycle.

As followed are instructions for Installing and using the Fat Tire assembly on a shaft drive Motorcycle:

1. Remove the original Fender, old Swing-arm, and side frame support and gas tank. (Empty Gas Tank before Removing It).

2. Drain plug in gas tank must be changed you will use a small flush Allen head plug, the reason for this is because the old drain plug would interfere with the new Fat Tire assembly. Install small flush drain plug, use sealant, put gas tank aside for now.

3. Have someone help you install the new swing-arm the same way you removed the old one. Do Not forget trust rings and bearing seals, (you will be using original trust rings and bearings seals) the new swing-arm is machined to accept them. You will use new bearings; make sure to grease them well.

4. Set new swing-arm in position, make sure input shaft and yoke splines engage correctly hold new swing-arm at 45 degree angle and slide into yoke. Install special pivot bolts (be sure to use a pivot bolts that will adjust from side to side.) do not use excessive pressure on pivot bolts, as this will distort the new swing-arm. Use just enough pressure, so there is no side to side movement. It is very important to keep the input shaft inline FIG. 1C. This is done with a dial indicator you can buy or by placing a piece of masking tape on top of Housing, marking it with a pencil (small line) use a piece of welding wire fixed to anything on the motorcycle. Bend the free end over the line you drew on tape. Now when you tighten it you can see if it moves to the left or to the right. You do not want it to move, you want it to stay directly in the center. Input shaft and yoke in line.

5. Reinstall gas tank make sure plug is properly installed as it will be difficult to get at it later. Let new Swing-arm pivot down, now you can reinstall the gas tank. When reinstalling gas tank remove the two rubber shims that are located on the top side of gas tank, they will be used at a later time, when you reinstall the new fender.

6. Installing the rear wheel: install rear rotor on carrier using original Allen heads, make sure drive shaft is in new swing-arm you must install final drive unit on wheel, and do not forget small drive shaft tension pressure spring. Make sure drive shaft is in new swing-arm, and drive shaft spline is engaged. Roll the wheel into the new swing-arm; use 4 Allen head nuts, instead of acorn nuts. Snug the four nuts. At this time shocks are not on the motorcycle yet, this makes it easier to roll the wheel in. Push rear wheel axel through; make sure all brake components are in proper position. Leave caliper off caliper support rod, install caliper last and make sure it is in the center of the rotor. With axel through wheel, now you can tighten four Allen head nuts that are supporting the final drive unit. Install caliper and brake line.

7. Installing shocks: Attach all hard ware; the two longest spacers are the upper shock spacers. Make sure that the left frame support bracket does not rub the side of the new swing-arm and the frame support bracket.

8. Grab Rail and fender Installation: At this point of the installation a custom wider fender and modified grab rail is attached to the motorcycle to accommodate the wider wheel assembly.

9. A custom tail light assembly and a side marker plate holder are also included in the final application.

10. Remember to fill the unit with good quality gear oil, as this in very important.

1. What I claim as my Invention is a shaft drive motorcycle swing-arm assembly with a Transmission incorporated into it that is designed to adapt to all shaft drive motorcycles.

2. What I claim as my Invention is the offset rotary transmission means, incorporated into a drive shaft motorcycle swing-arm that turns the drive shaft, thus rotating the wheel keeping the center of the rear wheel in the center line of the said motorcycle.
